(19) United States
(12) Patent Application Publication
(10) Pub. No.: US 2017/0316407 A1
(43) Pub. Date: Nov. 2, 2017

(54) TRANSACTION SYSTEM AND METHOD

(71) Applicant: EINNOVATIONS HOLDINGS PTE. LTD., Singapore (SG)

(72) Inventors: Mario Miranda LAZARO, Makati City (PH); Edward Joseph Pineda INZA-CRUZ, Makati City (PH); Oliver Laurito UBALDE, Makati City (PH)

(73) Assignee: EINNOVATIONS HOLDINGS PTE. LTD., Singapore (SG)

(21) Appl. No.: 15/528,765

(22) PCT Filed: Nov. 24, 2015
(86) PCT No.: PCT/SG2015/050468

§ 371 Date: May 23, 2017

(30) Foreign Application Priority Data
Nov. 25, 2014 (SG) 10201407807U

(51) Int. Cl. G06Q 20/38; G06Q 20/10; G06Q 20/20; G06Q 20/40

(52) U.S. Cl. CPC G06Q 20/385; G06Q 20/40; G06Q 20/1085; G06Q 20/20

(57) ABSTRACT

An over-the-counter (OTC) transaction system comprising a computing device operable to send a transaction request to initiate a transaction; and a server operable to receive an OTC electronic transaction request from a computing device and thereafter generate a unique identifier based on the transaction request received from the computing device as part of the transaction; the server further operable to verify the transaction based on the generated unique identifier; and upon verification, process and inform the computing device a status of the transaction; wherein the verification includes comparing a portion of the unique identifier with the entries in a whitelist maintained by the server; and wherein the unique identifier is temporary and is configured to expire after a predetermined criteria is met.

### FIELD OF THE INVENTION

The invention relates to a transaction system and method. In particular the invention is suited for transferring funds between users and is especially suited, but not limited to Over-the-Counter (OTC) deposits for the payment of online transactions and will be described in such context.

### BACKGROUND TO THE INVENTION

Throughout the specification, unless the context requires otherwise, the word “comprise” or variations such as “comprises” or “comprising”, will be understood to imply the inclusion of a stated integer or group of integers but not the exclusion of any other integer or group of integers.

Furthermore, throughout the specification, unless the context requires otherwise, the word “include” or variations such as “includes” or “including”, will be understood to imply the inclusion of a stated integer or group of integers but not the exclusion of any other integer or group of integers.

The following discussion of the background to the invention is intended to facilitate an understanding of the present invention only. It should be appreciated that the discussion is not an acknowledgement or admission that any of the material referred to was published, known or part of the common general knowledge of the person skilled in the art in any jurisdiction as at the priority date of the invention.

Online transactions are becoming widespread and many merchants allow consumers to purchase goods and services via the Internet. Payment options include the use of Credit Cards, Debit Cards, Automated Teller Machine (ATM) Cards, Mobile Wallets or Over-the-Counter (OTC) Deposit.

One of the easiest options without requiring any prerequisite to be fulfilled before purchasing online is OTC Deposit, since no credit card or bank account is required. A typical example of this method of payment would have the consumer select Online Payment or transaction (hereinafter referred to as OnlinePay) as a payment option (with a particular bank), which triggers OnlinePay to send deposit instructions to the consumer via email. The consumer then proceeds to the particular bank to deposit the payment into the account using information found in the email, would contain the bank account number and name to be used when depositing. A deposit slip is obtained after a successful deposit, which would have information such as have the date and time of the transaction, the code/name of the bank branch and the amount deposited. Using the same email, the consumer then confirms the transaction to OnlinePay via a link, which calls up a form requiring details found on the deposit slip. OnlinePay then informs the once this deposit is verified and validated, and a further email indicating this is sent to the consumer, and the merchant should complete the process by providing the chosen goods or service.

One problem with this existing method of payment is that it requires the consumer to confirm or validate the deposit made in order to effect the payment to the merchant. If this is not done, OnlinePay will have to reconcile the payments received manually or by batch process (usually daily) which would result in a delay in paying the merchant and hence a delay in completing the order or purchase.

There exists a need for a system having a more efficient process of validation without having to compromise security of the transactions, where a consumer is able to select OTC Deposit without having to further validation, as well as use the system for other applications like bill payment and remittance, to at least alleviate one or more of the above-mentioned problems.

### SUMMARY OF THE INVENTION

Throughout this document, unless otherwise indicated to the contrary, the terms “comprising”, “consisting of”, and the like, are to be construed as non-exhaustive, or in other words, as meaning “including, but not limited to”.

The above and other problems are mitigated and an improvement in the art is made by a system in accordance with this invention. A first advantage of the system in accordance with this invention is that the processing and validation is automated and the number of steps to completing the transaction is reduced via allowing an online transaction to be authorized by using a token in the form of a unique identifier, such as, but not limited to, a temporary primary account number (TPAN). A second advantage of the system in accordance with this invention is that it provides a secure way of remitting money, settling bills, providing lines of credit and gifting an electronic gift certificate, especially when the information and token is sent directly to the user's computer account or mobile device. A third advantage of the system in accordance with this invention is that user error is reduced because of the automated fund transfer, which allows the user to quickly and securely ensure that the transaction proceeds.

In one aspect of the present invention there is provided a transaction system comprising a first computing device capable of performing an online transaction, wherein the online transaction involves a transfer of funds; a server operable to generate a unique identifier based on a first request from the computing device as part of the online transaction; a second computing device capable of verifying the transfer of funds based on the unique identifier and said second computing device operable to send a second request to the server to update accordingly; wherein said server is operable to process the second request and inform the computing device whether online transaction was successful.

In another aspect of the invention there comprises an over-the-counter (OTC) transaction system comprising a server operable to receive an OTC electronic transaction request from a computing device and thereafter generate a unique identifier based on the transaction request received from the computing device as part of the transaction; the server further operable to verify the transaction based on the generated unique identifier; and upon verification, generate a status of the transaction; wherein the verification includes comparing a portion of the unique identifier with at least one entry in a whitelist maintained by the server; and wherein the unique identifier is temporary and configured to expire after a predetermined criteria is met.

Preferably, the transaction includes a transfer of funds for payment of a purchase made at an online store; and the server, upon processing the transaction request is operable to inform the online store whether the status of the transaction was successful.

Preferably, the unique identifier is in the format of a Primary Account Number (PAN).

Preferably, the unique identifier is in format of a sixteen alphanumeric PAN.

Preferably, the unique identifier is associated with a predetermined transaction amount. The predetermined criteria may include a predetermined time period.

Preferably, the transaction system further comprises a database in data communication with the server for storing records of unique identifiers and associated information. There further comprises a database management system for managing the data stored in the database, the database management system operable to store a record of transactions in relation to the unique identifier as well as at least one security code.

Preferably, the server is in data communication with a bank account and the server permits access to the bank account in response to input of both the unique identifier and the security code.

Preferably, the system comprises a payment counter in the form of a point of sale terminal or Automated Transaction Machine (ATM) for completion of the OTC transaction.

In another aspect of the invention there comprises a mobile device in data communication with the OTC transaction system for performing an OTC transaction according to any one of the preceding claims, wherein the mobile device is operable to send an OTC electronic request to the server.

In another aspect of the invention there is a method for over-the-counter (OTC) transaction comprising the steps of: sending an OTC electronic transaction request from a computing device to a server as part of an online transaction; and upon receipt of the electronic transaction request, generating a unique identifier by the server; verifying the transaction based on the generated unique identifier; and upon verification, processing and generating a status of the transaction; wherein the verifying step includes comparing a portion of the unique identifier with at least one entry in a whitelist maintained by the server; and wherein the unique identifier is temporary and configured to expire after a predetermined criteria is met.

Preferably, the OTC electronic request includes information regarding a merchant to be paid, and the transaction amount.

Preferably, the unique identifier is associated with a predetermined bank account.

Preferably, the unique identifier generated by the server is in the same format as a bank account number.

Preferably, the unique identifier is associated with a predetermined transaction amount.

Preferably, the unique identifier expires after a predetermined time period.

Preferably, the unique identifier is sent via a separate communication channel to the computing device.

Preferably, the step of the server generating a unique identifier and keeping a record of the online transaction further comprises the step of informing the computing device the status of the online transaction.

Preferably, the server generates a security code when generating a unique identifier.

In another aspect of the invention there comprises a non-transitory computer readable medium containing executable software instructions thereon wherein when executed and upon receiving a transaction request to initiate a transaction; performs the steps of generating a unique identifier based on the transaction request received; verifying the transaction based on the generated unique identifier; and upon verification, processing and informing a status of the transaction; wherein the verifying step includes comparing a portion of the unique identifier with at least one entry in a whitelist maintained by the server; and wherein the unique identifier is temporary and is configured to expire after a predetermined criteria is met.

### BRIEF DESCRIPTION OF THE DRAWINGS

The invention will now be described, by way of example only, with reference to the accompanying drawings, in which:

FIG. 1 shows a user doing an online transaction in which funds are transferred and verified by the server according with an embodiment of the invention;

FIG. 2 is an illustrative transaction flow view of the system and method in use.

Other arrangements of the invention are possible and, consequently, the accompanying drawings are not to be understood as superseding the generality of the preceding description of the invention.

### EMBODIMENTS OF THE INVENTION

Particular embodiments of the present invention will now be described with reference to the accompany drawings. The terminology used herein is for the purpose of describing particular embodiments only and is not intended to limit the scope of the present invention. Additionally, unless defined otherwise, all technical and scientific terms used herein have the same meanings as commonly understood by one or ordinary skill in the art to which this invention belongs. Where possible, the same reference numerals are used throughout the figures for clarity and consistency.

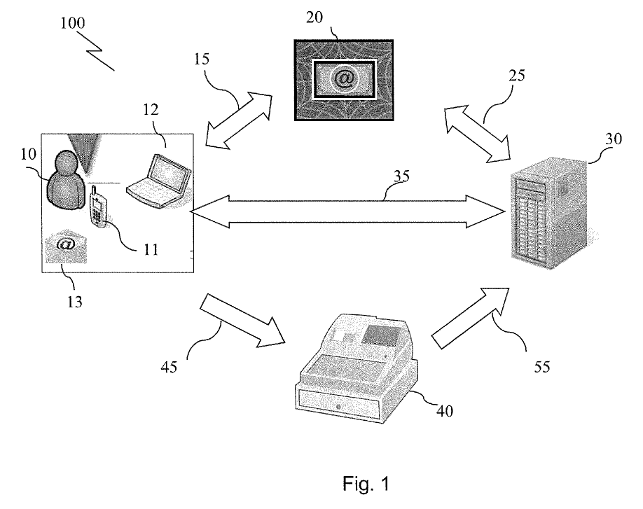

In accordance with an embodiment of the invention shown in FIG. 1, there is a transaction system 100 where a user 10 can use a computing device, which can be a mobile device 11 or a personal computer (or laptop) 12 or any other device capable of displaying and communicating with a payment portal that can be typically used by online merchants offering goods and/or services. The user interface for displaying and interacting with the payment portal is typically in the form of a website of a payment gateway of a merchant. The website is accessible by a user via a web browser of a personal computer 12 operably connected to be in data communication with other components of the transaction system 100 via a communication network, which includes (but is not limited to) 3G/4G, Wi-Fi connection to the Internet; direct LAN connection to the Internet; point of sale (POS) terminal; or Automated Teller Machines (ATM).

The user 10 would be registered with the transaction system 100 prior to utilizing the system. For a user utilizing a mobile device or smart phone 11, registration may include providing the Mobile Identification Number (MIN), tied to a SIM, of the user 10. The transaction system will then check the MSISDN of the mobile device 11 or other methods as well known to a skilled person. If the mobile device 11 is a not a subscriber, the user of mobile device 11 may be prompted a message to change the Access Point Name (APN) of the mobile device.

The use and operation of the Internet, computers and servers using software applications and payment portals are well known to persons skilled in the art and need not be described in any further detail herein except as is relevant to the present invention.

In the embodiment shown in FIG. 1, the user 10 proceeds to the payment or checkout option after completing the selection on a merchant, such as an online store website 20. The checkout option typically provides a review of the purchase or payment to be made as well as the payment options and the user selects ‘OTC Deposit’ on the website 20. The actual merchant providing the good(s) or service(s) can be distinct from the host of the website 20. Thereafter once the transaction is confirmed, typically by the user after reviewing the transaction request 25, the transaction request 25 is sent to the system server 30. This transaction request 25 can include information such as the merchant details, customer details, date, transaction amount etc. The system server 30 would record the transaction and generate a unique identifier. The transaction can be recorded and stored in a database (not shown) connected to the system server 30, possibly with a database manager managing the records. The system server 30 can include one or more processors with the requisite computing power to process the incoming transaction requests. The unique identifier can take the form of a Primary Account Number (PAN), a truncated PAN, a Temporary Primary Account Number (TPAN) or a number that follows the same format as bank account numbers. In particular, when the unique identifier is in the form of a TPAN, the TPAN can have logic or ‘rules’ associated with it and can be implemented and managed by the system server 30, for example allowing the TPAN to expire after a predetermined or preset time period like one month after the transaction request is recorded. Such rules may include rules associated with validation and security such as, for example, the alphanumeric numbers or codes forming the TPAN cannot have more than two consecutive repeated numbers; the codes cannot be in consecutive running order; any TPAN slated for reuse cannot be active for a past predetermined period of time (e.g. past 6 months), etc. In addition, such logic or rules, in addition to addressing security validation, may also address usability challenges that include industry standards, where applicable. The rules allow for the number of records to be minimised and manageable since the TPAN can be reused and recycled after some time. Other criteria for the expiry of the TPAN is also possible, for example, for a specific list of merchants, for merchants of general type (i.e. within another general list), and limitations on the transaction amount.

In some embodiments, TPAN is typically in the format of a PAN used in banking and financial transactions and comprises a 16-digit numeric generated by a pre-determined algorithm. The pre-determined algorithm may be based on a randomized or pseudo-random algorithm. The generation of TPAN can be carried out by a customer management system and this is fed to a database of TPANs. When a transaction is carried out, the system performs a look up on the database of TPANs, which in turn provides an un-assigned generic TPAN for the application requesting the transaction, and the database of TPAN thereafter marks the assigned TPAN as ‘released’ and links the assigned TPAN to the transaction record. When payment of the transaction is completed, the system marks or flags the assigned TPAN as ‘paid’. The database of TPAN can be periodically refreshed so that the TPAN can be recycled in time for future use.

The generation of a TPAN may be tied to or is similar to the creation of an account number or unique identifier electronic wallet account. Such electronic wallet account allows a registered user/account holder to perform various transactions not limited to, for example, bill payment, reload of airtime, and money transfers using a registered mobile device, such as a smart phone device. In advanced electronic wallet systems hosted by telecommunications carrier or networks and is tied to one or more mobile accounts of a user, the ATM and debit card transactions may also performed using the electronic wallet account.

The TPAN is independent from a bank account, although a further embodiment of it would see it being generated or derived from a PAN that it is associated with. The TPAN can be associated with a specific transaction amount, such that any transactions to the TPAN would be for a specific amount, allowing ease of administration when the system or a merchant is ensuring that a transfer of funds was successful.

Once the TPAN is generated, the system server 30 then sends a reply to the merchant website 20 for the transaction result to be displayed to the user 10. This reply is either an approval of the transaction or a message that the transaction is declined. Further notifications can be provided to the merchant and the system operator in the form of (but not limited to) email, html file or in the form of updated database records.

Separately, the user 10 would receive a notification 13 from the system server 30, and this can be in the form of an email, short message service (SMS) message(s) or any other messaging service 35. This notification 13 would contain the unique identifier, like the TPAN, as well as instructions on the deposit of funds. Heading to a payment center 40, the user can deposit 45 the required amount by providing the TPAN together with cash or any other forms of payment to the payment center 40. The payment center 40 can check that the amount is correct and facilitates the deposit via a front-end tool, which can be a manned counter with a computer or mobile device connected to the server 30 via the Internet or any other communication network, or an ATM that allows the deposit of funds. This facilitation triggers a request 55 to the server 30, and the server 30 processes the transaction, verifies the transaction amount and updates the TPAN record, thereafter notifying the merchant website 20 that the payment is made. A further notification 13 is provided to the customer by either the merchant website 20 or the server 30 regarding the status of the order and the transaction is completed when the merchant completes the order. In the case where the host of the website store 20 is different from the merchant, the website would inform the merchant accordingly (not shown in Figure).

Mobile networks can also be used in the system for greater efficiency and for the implementation of certain components as described earlier. For example the mobile number (MIN) of a subscriber can be enrolled in the system so that all generated unique identifier or TPAN are sent via email and/or SMS, such that payment or transaction based on the TPAN can be done through the subscriber's account with the mobile phone operator or any other monetary deposit scheme. This can even be carried out by mobile phone applications designed to allow the transfer of funds to and from the subscriber's account. This allows for the validation of the TPAN in real time quickly and efficiently, and allows the transaction to proceed. The subscriber is also notified via mobile phone, preferably a smart phone that the TPAN transaction has been successfully carried out. A dedicated software application (colloquially known as ‘app’) may be installed on a smartphone device providing the necessary user interface. The SIM application toolkit (STK) of the smartphone device may be utilized to validate and perform the necessary transfer from a subscriber account to the TPAN account.

A variation of the transaction system 100 can be used to settle bills, where instead of a merchant, a billing agency present payment options via a website 20 and the user 10 choses OTC deposit as a payment option. The website 20 would send a transaction request 25 to the server 30, which would contain information such as the billing agency's name, company number, transaction amount, etc. The server 30 would generate the TPAN and record the transaction, informing the user via the website 20 whether the transaction was successful. Separately, the user 10 would receive a notification 13 from the system server 30 containing the unique identifier, like the TPAN together with instructions on the deposit of funds. Heading to a payment center 40, the user can deposit 45 the required amount by providing the TPAN together with cash or any other forms of payment to the payment center 40. The payment center 40 can check that the amount is correct and facilitates the deposit via a front-end tool, which can be a manned counter with a computer or mobile device connected to the server 30 via the internet or any other communication network, or an ATM that allows the deposit of funds. This facilitation triggers a request 55 to the server 30, and the server 30 processes the transaction, verifies the transaction amount and updates the TPAN record, the server transmit payment to the billing agency and informs them that payment has been made with respect to the user's bill. If required, a further notification can be sent to the user that the bill was paid although typically the transaction from the user's point of view would end with the transfer of funds at the payment center. It is envisaged that a similar system and method can also be used to provide a line of credit or a loan account from a credit provider. TPAN can also be used as an electronic gift certificate or voucher.

A TPAN may be validated using a method that involve the steps of: mapping a portion of a set of numbers; performing a verification step based on a whitelist or lookup table maintained by the server 30, the verification step includes checking whether a mapped portion of the TPAN corresponds with at least one entry in the whitelist or lookout table The step of mapping a portion of a set of numbers also includes data to validate several factors including time, date, merchant category, transaction category, payment preference, etc.

It is to be appreciated that the arrangement where TPAN validation and service fulfilment is performed by the SIM card (installed on a mobile device) and SMS server achieves the following advantages:
1. Allowing any individual and/or corporation to be enrolled as a payment partner;
2. Reduce costs on payment processing; and
3. Process payments at speed of sending or processing text messages like SMS.

Compared to prior art systems, it is to be appreciated that the validation of TPAN is performed at or near real time. Prior art system is non real-time, and in particular the generation of reference codes for validation does not follow the card security industry standards (e.g. PAN) which therefore limits the implementation of such systems in online transaction.

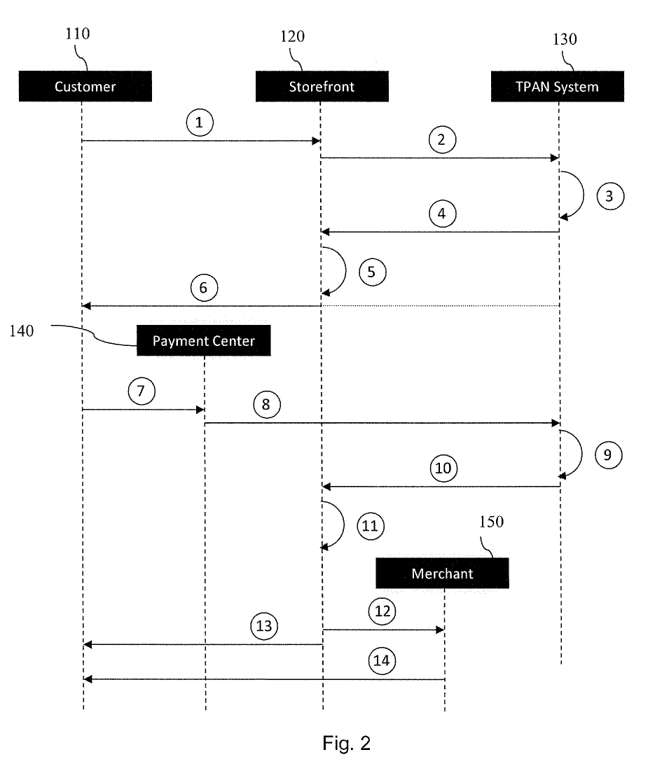

FIG. 2 shows the transaction flow of how transaction can be carried out. Before the transaction it is to be appreciated that the customer 110 would have registered with a TPAN system 130 using at least his mobile identification number (MIN). The TPAN system 130 comprises one or more servers operable to process OTC transaction requests. Such requests may be in the form of electronic transaction requests. The steps 1 to 14 labelled in the figure are described as follows:

Step 1. Customer 110 browses Merchant's online storefront 120 and selects item/s to be purchased. Once done, the customer 110 proceeds to checkout page, reviews purchase details and selects OTC Deposit as payment option. Once transaction is confirmed, a transaction request is sent.

Step 2. Transaction request is sent to the backend server 30 comprising one or more processors/servers that is part of the TPAN system 130. The transaction request includes the information of the merchant as well as the transaction amount.

Step 3. The TPAN system 130 generates a TPAN and records the transaction.

Step 4. The TPAN System 130 sends a reply to the Storefront 120.

Step 5. The transaction result is displayed to the customer 110.

Step 6. The Customer 110 receives a notification, such as an email notification, containing the TPAN and deposit instructions. This email notification can be sent by the merchant and the email notification provides the Customer 110 with details on making the payment. Alternatively the notification may be in other format not limited to email. The notification originating from the merchant serves to acknowledge that payment has been validated and goods and/or services purchased online are ready for delivery.

Step 7. The Customer 110 proceeds to a Payment Centre 140 to deposit the required amount. Gives cash and TPAN details to the Payment Centre 140 personnel.

Step 8. The Payment Centre 140 personnel facilitate deposit to the TPAN 140 via front-end tool (online or mobile). Request is sent to the backend server.

Step 9. The TPAN System 130 processes the transaction, verifies transaction amount and updates TPAN record.

Step 10. The TPAN System 130 notifies Storefront 120 of the payment made. The TPAN System 130 can also notify the Customer 110 (via SMS or other known means) that the transaction is successful.

Step 11. The Storefront 120 updates order status.

Step 12. The Storefront 120 sends a notification to the Merchant 150 regarding the pending order.

Step 13. The Storefront 120 sends a notification to the Customer 110 regarding the order status.

Step 14. The Merchant 150 fulfils order and the transaction is completed.

In another embodiment, the transaction system 100 can also be used for a remittance type of transaction. This is initiated by when the user goes to a payment centre to initiate the transaction together with the funds to be remitted. The payment centre can be a manned counter with a computer or mobile device connected to the server, or an ATM that allows the deposit of funds. The payment centre checks or verifies that the amount of funds is correct and encodes the transaction and sends a request to the server. The request typically would contain the transaction amount, the user's (sender's) details such as name, email address, mobile number, etc, the beneficiary's details such as name, email address, mobile number etc. The server would generate the TPAN together with a security code and records the transaction, thereafter sending the transaction result to the payment centre. The user would then receive a notification via email or SMS from the server containing the TPAN as well as a summary of the transaction, while the beneficiary would receive a notification from the server via email or SMS containing the security code. The user then provides the TPAN to the beneficiary through ordinary communication channels, and the beneficiary can then proceed to a payment counter such as an ATM, to withdraw the remitted funds. The beneficiary would have to input the TPAN as well as the security code, which would trigger a request to the server. The server processes the transaction and updates the TPAN record, informing the payment centre of a successful update, and the payment centre dispenses the funds accordingly.

The embodiments described may include a database management system for managing data stored in the whitelist and/or database of unique identifiers, the database management system for storage of a record of transactions in relation to the unique identifier, such as TPAN, as well as a security code. The data management system, via the server 30, may be in data communication with a bank account of the transacting user, and the server permits access to the bank account in response to user input of both the unique identifier and a security code upon successful verification.

In accordance with another embodiment of the invention there comprises a non-transitory computer readable medium containing executable software instructions thereon wherein when executed and upon receiving a transaction request to initiate a transaction; performs the steps of generating a unique identifier based on the transaction request received; verifying the transaction based on the generated unique identifier; and upon verification, processing and informing a status of the transaction; wherein the unique identifier is temporary and is configured to expire after a predetermined criteria is met.

The transaction may be an online transaction as exemplified in the earlier embodiments. Accordingly the transaction request may be an online transaction request.

The unique identifier may be a PAN or TPAN as mentioned in the earlier embodiments.

The non-transitory computer readable medium may be installable on the system server 30 and when executed, process, verifies and inform whether the transaction is successful or not, amongst other statuses.

In the various embodiments, it is to be appreciated that the unique identifier or TPAN in the format of a PAN used in banking and financial transactions may include any PAN having any length of alphanumeric sequence generated by a pre-determined algorithm.

The above are description of embodiment(s) of a transaction system and in particular a transaction system for transferring funds between users. It is envisioned that those skilled in the art can and will design alternative embodiment(s) of this invention without departing from the scope of the present invention. For example, connection to the server 30 using a mobile phone may be via Internet or other communication network such as, but not limited to, SMS communication protocol and Unstructured Supplementary Service Data (USSD) protocol. This is particular relevant to feature phones (i.e. non smartphones).

It would be further appreciated that although the invention covers individual embodiments, it also includes combinations of the embodiments discussed. For example, the features described in one embodiment is not being mutually exclusive to a feature described in another embodiment, and may be combined to form yet further embodiments of the invention.

1. An over-the-counter (OTC) transaction system comprising:
a server operable to receive an OTC electronic transaction request from a computing device and thereafter generate a unique identifier based on the transaction request received from the computing device as part of the transaction; the server further operable to verify the transaction based on the generated unique identifier; and upon verification, generate a status of the transaction;
wherein the verification includes comparing a portion of the unique identifier with at least one entry in a whitelist maintained by the server; and wherein the unique identifier is temporary and configured to expire after a predetermined criteria is met.

2. The transaction system of claim 1, wherein the transaction includes a transfer of funds for payment of a purchase made at an online store; and the server, upon processing the transaction request is operable to inform the online store whether the status of the transaction was successful.

3. The transaction system of claim 1 or 2, wherein the unique identifier is in the format of a Primary Account Number (PAN).

4. The transaction system of claim 3, wherein the unique identifier is in format of a sixteen alphanumeric PAN.

5. The transaction system of claim 3, wherein the unique identifier is associated with a predetermined transaction amount.

6. The transaction system of claim 3, wherein the predetermined criteria is a predetermined time period.

7. The transaction system of claim 3 further comprising a database in data communication with the server for storing records of unique identifiers and associated information.

8. The transaction system of claim 7, further comprising a database management system for managing the data stored in the database, the database management system storing a record of transactions in relation to the unique identifier as well as a security code.

9. The transaction system of claim 8, wherein the server is in data communication with a bank account and the server permits access to the bank account in response to input of both the unique identifier and the security code.

10. The transaction system of any one of the preceding claims, the system comprises a payment counter in the form of a point of sale terminal or Automated Transaction Machine (ATM) for completion of the OTC transaction.

11. A mobile device in data communication with the OTC transaction system for performing an OTC transaction according to any one of the preceding claims, wherein the mobile device is operable to send an OTC electronic request to the server.

12. A method for over-the-counter (OTC) transaction comprising the steps of:
sending an OTC electronic transaction request from a computing device to a server as part of an online transaction;
upon receipt of the electronic transaction request,
generating a unique identifier by the server;
verifying the transaction based on the generated unique identifier; and upon verification,
processing and generating a status of the transaction;
wherein the verifying step includes comparing a portion of the unique identifier with at least one entry in a whitelist maintained by the server; and wherein the unique identifier is temporary and configured to expire after a predetermined criteria is met.

13. The method of claim 12, wherein the OTC electronic request includes information regarding a merchant to be paid, and the transaction amount.

14. The method of claim 12 or 13, wherein the unique identifier is associated with a predetermined bank account.

15. The method of claim 14, wherein the unique identifier generated by the server is in the same format as a bank account number.

16. The method of claim 14, wherein the unique identifier is associated with a predetermined transaction amount.

17. The method of claim 14, wherein the unique identifier expires after a predetermined time period.

18. The method of claim 12, wherein the unique identifier is sent via a separate communication channel to the computing device.

19. The method of claim 12, wherein the step of the server generating a unique identifier and keeping a record of the online transaction further comprises the step of informing the computing device the status of the online transaction.

20. The method of claim 14, wherein the server generates a security code when generating a unique identifier.

21. A non-transitory computer readable medium containing executable software instructions thereon wherein when executed and upon receiving a transaction request to initiate a transaction; performs the steps of generating a unique identifier based on the transaction request received; verifying the transaction based on the generated unique identifier; and upon verification, processing and informing a status of the transaction; wherein the verifying step includes comparing a portion of the unique identifier with at least one entry in a whitelist maintained by the server; and wherein the unique identifier is temporary and is configured to expire after a predetermined criteria is met.
